(19) United States
(12) Patent Application Publication
(10) Pub. No.: US 2005/0115639 A1
(43) Pub. Date: Jun. 2, 2005

(54) Multifunctional auxilliary base system for electric woodworking routers

(76) Inventor: Ralph Wayne Bagnall, Goshen, NH (US)

Correspondence Address: Ralph W. Bagnall, 647 Washington Rd, Goshen, NH, 03752, US

(21) Appl. No.: 10/964,439

(22) Filed: Oct. 12, 2004

Related U.S. Application Data
(60) Provisional application No. 60/520,388, filed on Nov. 17, 2003.

(51) Int. Cl. B27C 5/10

(52) U.S. Cl. 144/218

(57) ABSTRACT

A multifunctional auxiliary base plate 11 for an electric woodworking router allowing the use of a wide range of accessories being attached to the base through a profiled slot 13 formed into base 11. A user of the auxilliary base-equipped router can utilize the tool as an offset base in a manner well known in the art, and then attach other accessories, without the use of tools, and without needing to remove the base plate from the router. Further, the bit opening in the base plate can be attached with a variety of throat plate inserts 25, 25A, or guide bushing adapter 25B.

### CROSS REFERENCE TO RELATED APPLICATIONS

60/520,388

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to hand held woodworking routers, specifically an auxiliary base that allows users to switch tasks, guides and accessories quickly, even between different sizes and brands of routers.

2. Background of the Invention

Hand-held woodworking routers can perform a wide range of tasks and this utility can be greatly increased by attaching auxiliary bases, guides and other accessories. Offset bases for added control and stability, edge guides for rabbet and dado milling, circle cutting jigs, center cutting adapters, dust collectors, curved edge guides, and a host of other add-on bases expand the usefulness of the hand held routers.

Often, changing these bases and accessories requires tools and time that the woodworker can better employ in other ways. Further difficulties are encountered if a woodworker owns more than one brand or size of router, since each may have specific and distinctive mounting holes. This means that these jigs and fixtures are generally usable only on one brand or size of router.

An additional problem is encountered in the bit opening of the router base plate. For maximum safety and best results, the base plate opening should be sized properly for the bit being used, and template routing requires a special base plate that accepts some form of guide bushing. This is typically accomplished by switching between base plates with differing sized openings, or with changeable openings in a single base plate.

Lastly, specific and specialized tasks may require a purpose-built accessory, necessitating the user to create their own requiring yet another base plate change-over.

Inventors, tool suppliers and woodworking authors have acknowledged these issues, and solutions have been presented any number of times both in the marketplace and in print.

For example Eagle America Corp. offers in their catalog an auxiliary base plate called a “Router Tri-Jig” that incorporates an offset base with an edge guide and circle cutter. This same company also offers for sale a different base plate called a “4-in-1 Universal Router Base Plate” that addresses the bit opening issue, but these two are not designed to be used together or in conjunction with any other accessory.

ShopNotes Issue 61, Volume 11, contains plans and instructions for an auxiliary base system that can perform five separate functions without changing the base, but the system is limited to those five operations, and cannot use guide bushings.

U.S. Pat. No. 5,452,751 to Engler and McCann, and U.S. Pat. No. 6,070,626 to Tully show router bases that perform multiple functions. The Engler and McCann design performs up to eight functions, but two different router mounting locations are required to utilize all of the functions, and is relatively large for hand-held router operations. This unit also lacks the ability to adjust the bit opening size. Tully shows a three-function base, but it is limited to three specific functions and also lacks the ability to size the opening for the bit.

In conclusion, insofar as I am aware, no router base or accessory provides for more than a fixed number of specific functions, and none can be easily moved between different styles or brands of routers. All of these bases, while useful, do not constitute a modular, systematic approach to increasing the router's functionality and limiting changeover time between functions, and none allow for easy custom adaptation by the user.

### BACKGROUND OF THE INVENTION—OBJECTS AND ADVANTAGES

The invention, an improved auxiliary router base plate for electric woodworking routers, contains a profile groove that accepts a mating profile beam. This profile beam is part of each accessory, allowing the user to switch accessories, and hence router functions, quickly and without tools, even switching accessories from one router to another. The profile of the groove and beam are such that the beam is self-centering on the groove maintaining a close tolerance relative to the base plate and the router. This groove and beam arrangement further allows the user to create custom accessories for specific tasks utilizing the auxiliary base plate, maintaining the ability to use these shop-built accessories between different routers.

The base plate also contains a means for clamping the beam, preventing movement once set. This clamping mechanism allows for positioning the accessories relative to the cutting edge of the tool and holding them in place during use.

The base plate further contains a means for switching between different throat plates to accommodate various diameters of bits and provide for the use of guide bushings.

### SUMMARY

In accordance with the present invention an auxiliary router base plate is comprised of a body having a profiled slot milled along the major axis to accept multiple tools and accessories. This router base plate, along with it's attendant accessories and throat plates comprise a cohesive, modular system for expanding the capabilities of the router, simplifying operational changes, allowing use of accessories between different types and brands of routers, as well as enabling the user to more easily create shop-built accessories for specific tasks.

### DRAWINGS—FIGURES

FIG. 1 shows the router base plate, a generic electric woodworking router, some, but not all, of the possible accessories mounted on the profile beam, and a number of the interchangeable throat plates.

FIG. 2 shows a left underside view of the router base plate including the profile groove, profile beam, locking tab access hole, grip block, grip knob and locking knob and one of the throat plates.

FIG. 3 shows the rear right of the base plate including the profile slot, locking tab access hole, router mounting holes, and grip block mounting holes.

FIG. 4 shows the underside of the router base plate in plan view with section view A-A showing the profile groove in cross section and B-B showing the throat plate groove in cross section.

FIG. 5 shows an exploded view of the grip block assembly showing the grip block, grip block base plate, locking tab, grip knob, locking knob, and the grip knob fastener.

FIGS. 6A-C show three views of the base plate 11 with alternative embodiments of the profile groove 13.

### DRAWINGS—REFERENCE NUMERALS

11 base plate
13 profile groove
15 grip block
16 grip block base plate
17 grip knob
18 grip knob fastener
19 locking knob
21 profile beam
21A edge guide
21B trammel guide
23 throat plate groove
24 throat plate mounting holes
25 throat plate
25A wide opening throat plate
25B bushing adapter throat plate
27 electric woodworking router
29 router mounting hole
31 locking tab
32 locking tab access hole
33 grip block mounting hole
34 grip knob mounting hole
35 locking knob mounting hole
36 clearance hole
37 guide bushing
37A guide bushing lock nut

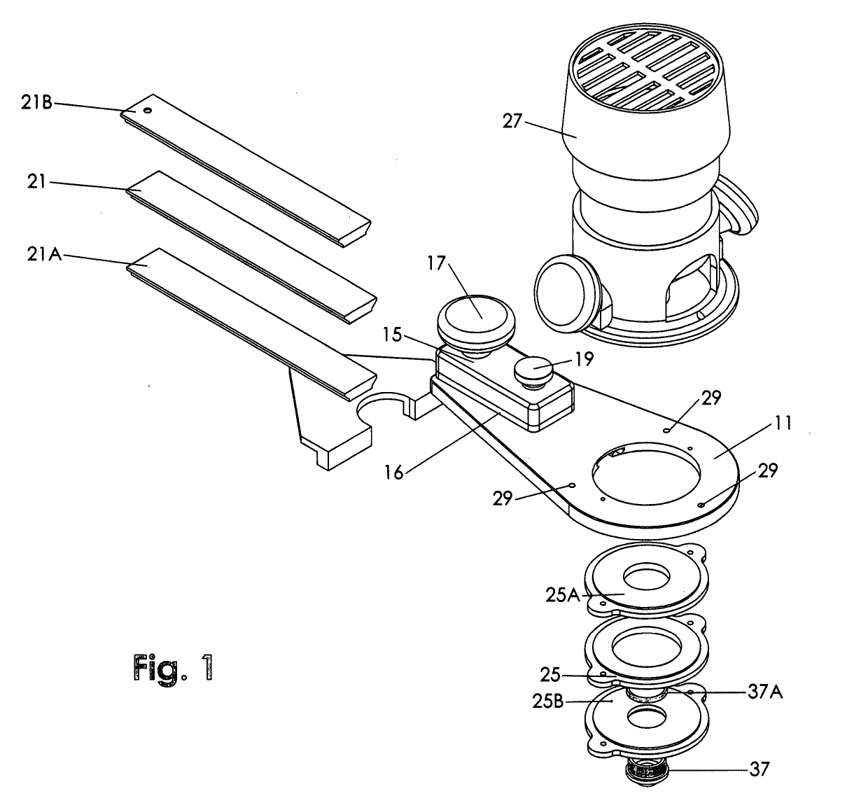

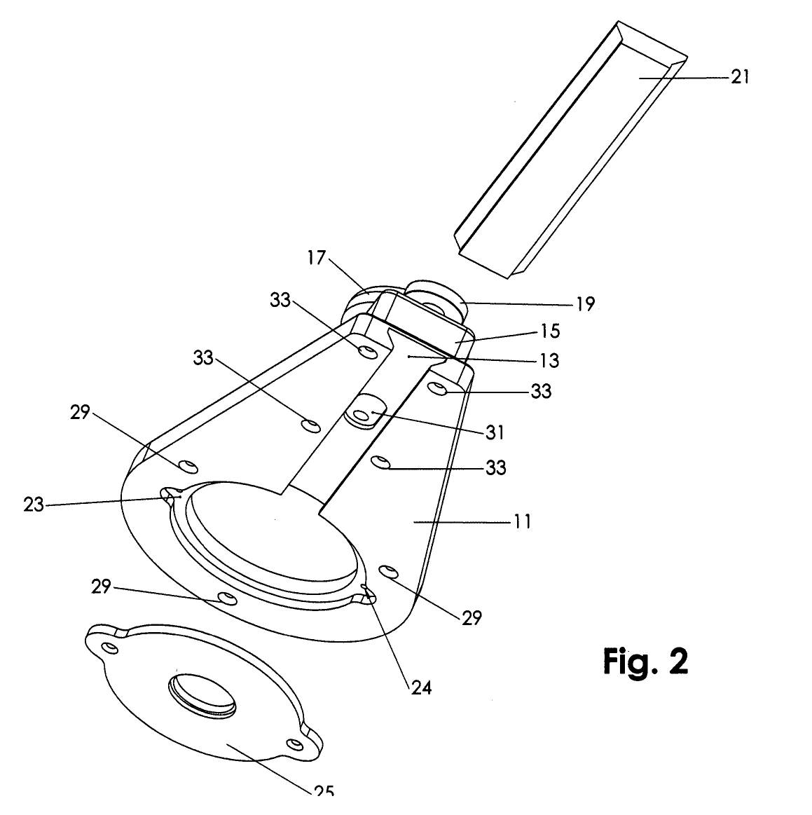

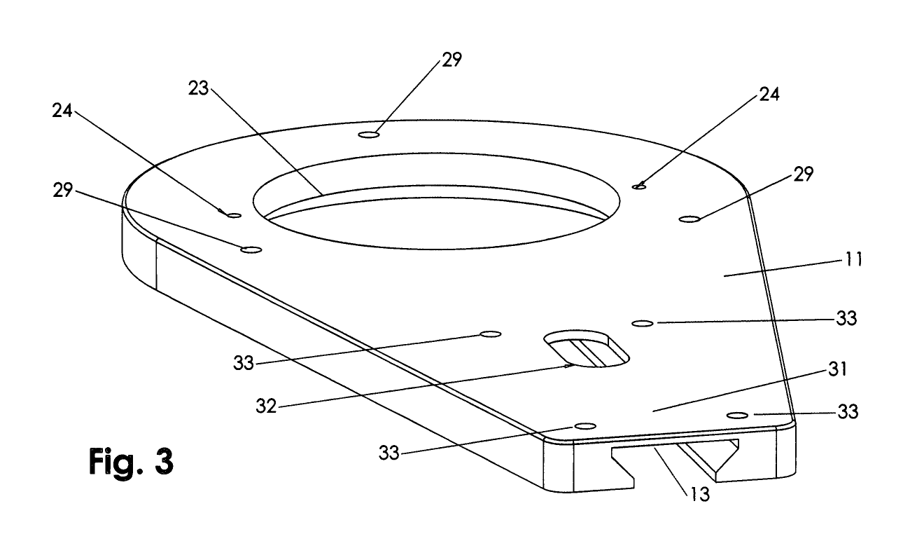

### DETAILED DESCRIPTION—FIGS. 1-5 PREFERRED EMBODIMENT

The preferred embodiment of the present invention is illustrated in FIGS. 1 through 5. In the preferred embodiment the base plate 11 is constructed of polycarbonate, however may be constructed of any material of similar stiffness and dimensional tolerance such as nylon, wood, metal or phenolic in accordance with the invention.

The base plate 11 of the invention has router mounting holes 29 on the primary, or wider, end for attaching an electric woodworking router 27. Located concentrically between said router mounting holes 29 is an opening, known as a throat in the art, for the router bit to extend through the base plate 11 in order to reach the work piece. The lower edge of this throat contains a throat plate groove 23 and throat plate mounting holes 24 to locate and secure any one of several throat plates 25, 25A, 25B.

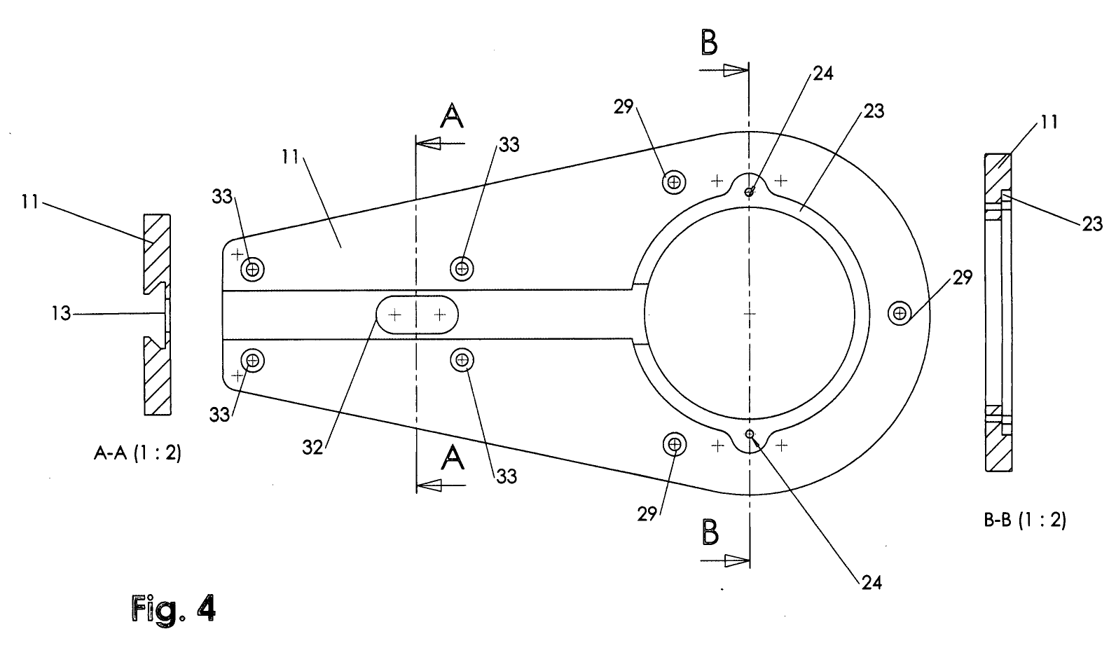

The base plate 11 also contains a profile groove 13 running longitudinally along the base plate 11 beginning at the throat and exiting the minor end of the base plate 11. In the preferred embodiment of the invention, the cross section of the profile is shown in FIG. 4 section A-A. A locking tab access hole 32 is provided through the top face of the base plate 11 extending into the centerline of the profile groove 13 providing access for the locking tab 31 to engage and secure the profile beam 21 when in use.

Grip block mounting holes 33 are provided on the minor end of the base plate 11 on each side of the profile groove 13 to secure the grip block plate 16 and grip block 15 to the base plate 11.

The invention further possesses a profile beam 21 with a cross section profile that closely fits into the profile groove 13 of the base plate 11 while retaining the ability to freely move longitudinally within the profile groove 13. In the preferred embodiment, this profile beam 21 is constructed of nylon or other material with similar stiffness and dimensional tolerance.

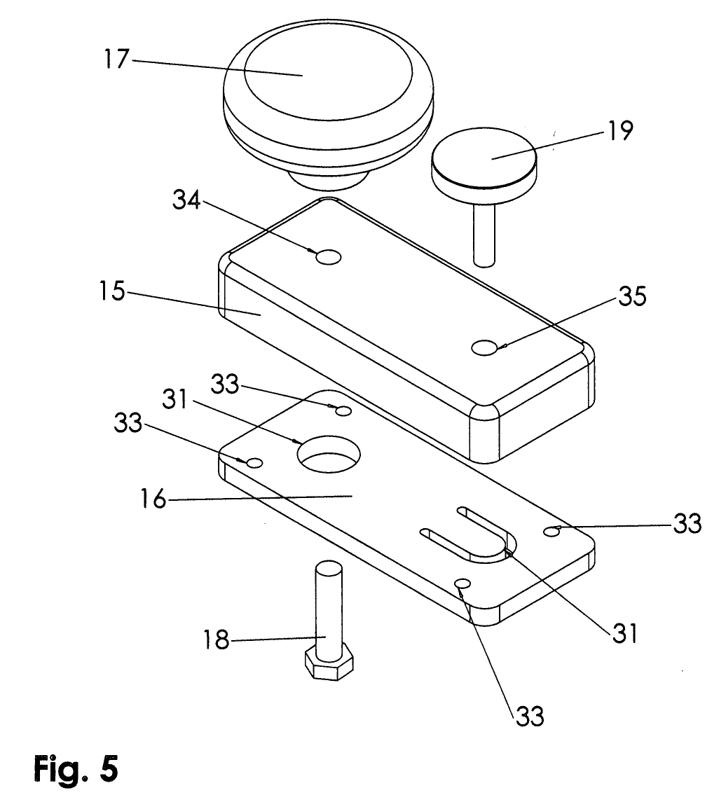

As shown in FIG. 5, the locking tab 31 is constructed as part of the grip block plate 16, and in the preferred embodiment, is fabricated from polycarbonate. This plate also provides a clearance hole 36 for the grip knob fastener 18 protruding from the grip block 15.

In the preferred embodiment the grip block 15 is constructed of wood. All perimeter edges and all top face edges are rounded. Two through holes are provided, a grip knob mounting hole 34 for the grip knob fastener 18 to pass through and a locking knob mounting hole 35 for the locking knob 19. The grip block 15 is mounted to the grip block base plate 16 and base plate 11 in such a fashion as to allow the stud of the locking knob to engage the locking tab 31. The locking knob 19 flexes the locking tab 31 through the locking tab access hole 32 in the base plate 11 thereby engaging the profile beam 21 preventing movement of the profile beam 21.

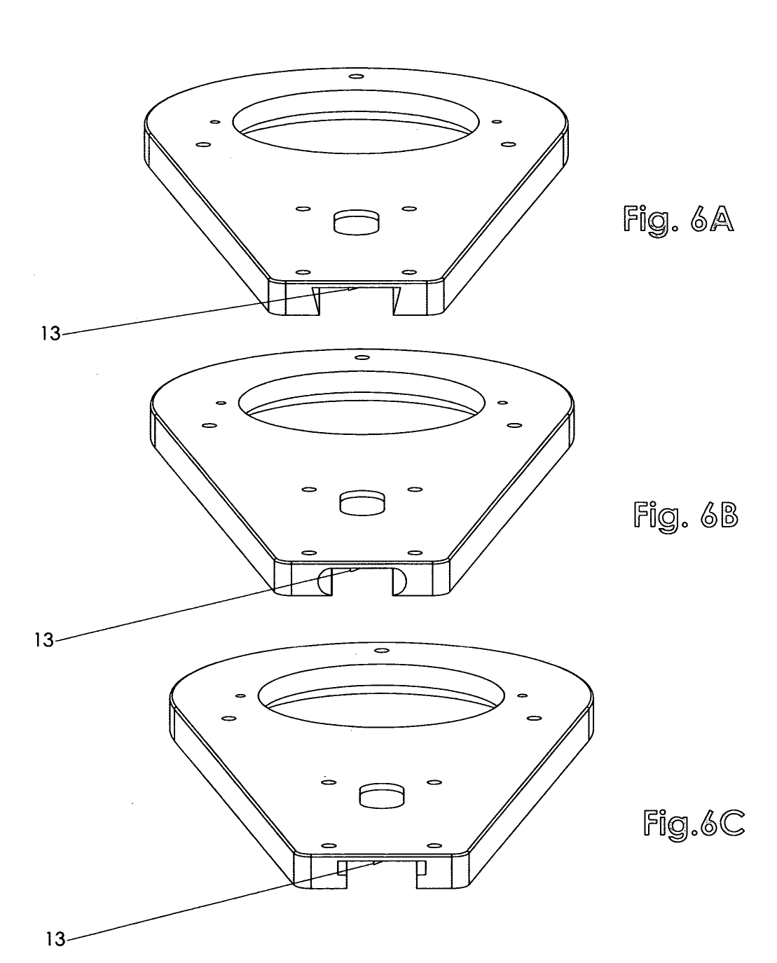

### FIGS. 6A, 6B, 6C—ALTERNATIVE EMBODIMENTS

While the profile groove 13 in base plate 11 is central to the purpose and scope of the invention, the shape of the profile groove 13 can be any one of a number of suitable shapes as shown in FIGS. 6A-C. The profile must be such that the profile beam 21 can only be moved longitudinally and not along any other axis. Provided this restriction, the actual shape of the profile groove 13 and the profile beam 21 is unimportant. Three possible alternative embodiments are shown. FIG. 6A shows a dovetail profile, FIG. 6B shows an oribund profile, and FIG. 6C shows a shouldered profile.

Operation

In operation the base plate 11 remains attached to the electric woodworking router 27 as the user performs the required milling operations. For using a bearing guided cutting tool for example, the flat profile beam 21 is inserted into the profile groove 13 to provide a smooth and flat base for the router. The additional area of the base plate 11 and the offset of the grip knob 17 from the cutting tool provides increased control of the entire system, particularly around the corners of the work piece where less that one quarter of a standard base plate would be in contact with the work piece. The rounded front portion of the base plate 11, being concentric to the cutting tool, allows for use in conjunction with a typical straight edge guide when needed.

To change over to routing with the edge guide 21A, the profile beam 21 is removed and replaced with the edge guide 21 A. The edge guide 21 A is set to the desired position relative to the cutting bit, and clamped in position using the locking knob 19.

In a like manner, many other tasks can be performed by mounting the appropriate accessories to the base plate 11. All such accessories include a profile beam 21 to allow for mounting to the base plate 11. A list of the possible accessories includes but is not limited to:
Profile beam 21 for offset base operations or mounting custom shop-built accessories.
Edge guide 21A for cutting dados and rabbets.
Variable radius edge guide for cutting rabbets and dados on curved parts.
Centering base for mortise and groove cutting.
Trammel guide 21 B for circle cutting.
Edge band trimmer.
Dust collection cup.
Router table insert plate.

In addition to utilizing the profile beam 21 and like accessories, the throat plate 25 can be changed to provide different throat opening sizes for different sizes of cutting tools. Providing a close fitting throat opening is widely recognized within the art as promoting operational safety and milling accuracy. An additional bushing adapter throat plate 25B is provided to accept a guide bushing 37, common to the art, for template routing.

1. An auxiliary base plate for a woodworking router comprising:
a. an elongated plate of rigid material having top and bottom surfaces with the one end possessing means for attaching an electric woodworking router in a manner known to the current art; and
b. an opening for the cutting bit to pass through the base, said opening further formed with a profile located radially along the bottom edge of said opening to accept any of a plurality of insertable throat plates; and
c. a profiled slot of predetermined cross sectional shape formed in said plate parallel to said top and bottom surfaces from said bit opening through the opposite end of said plate.

2. The accessory claimed in claim 1 including a plurality of profiled beams each formed with a profile insertable in said profiled slot,
a. and being attachable to any of a plurality of means for guiding the router tool, means well known in the current art and those purpose built by users of the invention; and
b. a means provided to the base plate of claim 1 for temporarily and adjustably holding said profiled beams within said profile slot of claim 1.

3. A method of sharing accessories between dissimilar electric woodworking routers comprising:
a. providing said electric woodworking router with an auxiliary base plate; and
b. providing said auxiliary base plate a means for attaching and removing any of a plurality commercially made or purpose built accessories; and
c. providing said accessories with a means for mating to said auxiliary base plate; and
whereby said accessories can be shared between any number of dissimilar electric woodworking routers equipped with said auxiliary base plate
whereby the user of an electric woodworking router equipped with said auxiliary base plate can create custom accessories sharable with any other electric woodworking router equipped with said auxiliary base plate.
